(19) United States
(12) Patent Application Publication
(10) Pub. No.: US 2014/0056581 A1
(43) Pub. Date: Feb. 27, 2014

(54) TIMER VALUE NEGOTIATION FOR PATH CONFIGURATION BASED ON RSVP-TE

(71) Applicants: Benoit Tremblay, Laval (CA); András Kern, Budapest (HU); Attila Takács, Budapest (HU)

(72) Inventors: Benoit Tremblay, Laval (CA); András Kern, Budapest (HU); Attila Takács, Budapest (HU)

(73) Assignee: TELEFONAKTIEBOLAGET L M ERICSSON (PUBL), Stockholm (SE)

(21) Appl. No.: 13/980,707

(22) PCT Filed: Jan. 21, 2011
(86) PCT No.: PCT/EP11/50826

§ 371 Date: Nov. 11, 2013

(51) Int. Cl. H04B 10/032

(52) U.S. Cl. CPC H04B 10/032
USPC 398/1

(57) ABSTRACT

The present invention relates to an ingress node (102, 700) and methods therein for Operation Administration arid Maintenance, OAM related to Resource Reservation Protocol-Traffic Engineering, RSVP-TE5 for obtaining attributes for timer values being assigned to a connection from the ingress node (102) via intermediate nodes (104, 106, 108, 110) to an egress node (112), during configuration of die connection. An interval of suitable tinier values for the intermediate nodes is specified. Configuration attributes are obtained for a timer value within an interval that is acceptable by the intermediate nodes and the egress node, based on the specified interval of suitable timer values. The obtained configuration attributes are applied during configuration of the connection from the ingress node via the intermediate nodes to the egress node, if the obtained configuration attributes are appropriate to the ingress node. Fine-tuning of connection related timers can therefore be achieved, decreasing the overall recovery time and the overall overhead.

### TECHNICAL FIELD

This invention pertains in general to the field of Operations, Administrations and Maintenance (OAM). More particularly the invention relates to resource ReSerVation Protocol (RSVP) with Traffic Engineering (TE) support of OAM.

### BACKGROUND

Generalized Multiprotocol Label Switching (GMPLS) has been developed as a control plane protocol suite for various transport technologies. Said GMPLS is able to control a wide range of connection oriented packet switched networks such as Multiprotocol Label Switching (MPLS), MPLS-Transport Profile (MPLS-TP), Provider Backbone Bridging with Traffic Engineering (PBB-TE). Also, GMPLS is able to control time slot switched Synchronous Digital Hierarchy/Synchronous optical networking (SDN/Sonet), and Optical Transport Networks (OTN). Thanks to recent extensions GMPLS is also able to control Wavelength Switched Optical Networks (WSON).

An additional GMPLS related activity in Internet Engineering Task Force (IETF) focuses on developing such signaling and routing extensions that allows covering multiple transport technologies with a single control domain.

The GMPLS comprises technology agnostic frameworks, which are able to establish various recovery constructs, and to configure the monitoring of the deployed connections.

Most transport technologies implement various sets of recovery functionalities, such as protection switching and rerouting of connections. Different recovery functionalities have significantly different characteristics, for instance in the form of different recovery times. In multi-technology networks multiple transport technologies can be organized into hierarchies. An OTN digital hierarchy connection may for instance carry multiple MPLS-TP connections. Then, in the case of single network impairment, it can be detected in multiple technologies, i.e. by both MPLS-TP and OTN, to mention two examples. These detecting technologies may then attempt performing recovery actions. However, these un-coordinated actions will result in that some of the recovery actions become useless, for the reason that some recovery actions use outdated state information for the connection that has been already restored by another technology.

It may also happen that a recovery action at a given layer is triggered just be fore a lower layer gets repaired, which results in that an under optimized route or undesirable instability in the network.

The currently widespread solutions to solve this problem rely on hold-off timers. A hold-off timer starts when a node detects resource impairment. The node performs the recovery action only after the hold-off timer expires. A mechanism based on hold-off timers allow recovery configurations which instructs one technology to wait for expected reactions of other technologies. The timer is set on per connection basis. The timer value to be selected can be optimized by increasing an overall recovery time without performing unnecessary recovery actions.

Recovery mechanisms of a functional specification of Generalized Multiprotocol Label Switching (GMPLS) can be utilized by applying hold-off timer based methods. GMPLS signaling extensions are therein provided that add the support of establishing path and segment recovery constructs. However, these extensions do not consider the multi technology recovery coordination aspects, as mentioned above.

Signaling extensions may also cope with the timer based recovery coordination. For this purpose the ingress node of a network defines hold-off and Wait-to-Restore (WTR) timers. Both timers will be carried as part of the protection configuration. In this way per-connection hold-off and WTR timers can be specified.

Once a connection with recovery capability is established, it may serve as a direct protected tunnel for client connections. Such tunnels form Traffic Engineering (TE)-Links such as regular data links and are advertised using Open Shortest Path First-Traffic Engineering (OSPF-TE) or Intermediate System to Intermediate System-Traffic Engineering (ISIS-TE). Amongst others, these advertisements specify recovery type and role provided by that link.

Most technologies monitor the health of an end-to-end connection to detect its failures and as a consequence to trigger recovery actions. GMPLS implements the configuration of such Continuity Check (CC) functions as part of OAM configuration framework.

Although existing GMPLS signaling methods allow the ingress node to configure the Continuity Check (CC) function and the hold-off timer per connection basis, these methods require that the ingress node has a priori knowledge about the detailed characteristics such as recovery time of the applied recovery method of each connection in every technology layers.

The already specified GMPLS signaling constructions requires a priori knowledge about the recovery capabilities of all network technologies in order to appropriately determine the CC configuration parameters and the hold-off timer. Currently, the traffic engineering information dissemination methods advertise only a sub-set of the required information. Therefore, suboptimal configuration may be determined causing increased recovery times.

Currently, such detailed attributes are not advertised in GMPLS and the current signaling mechanism is not able to determine these characteristics.

There is hence a need for an improved recovery method without said drawbacks.

### SUMMARY

The present invention seeks to mitigate, alleviate or eliminate one or more of the above-identified deficiencies in the prior art and disadvantages singly or in any combination and solves at least the above mentioned problems by providing an apparatus and a method therein according to the appended patent claims.

The general solution is to provide methods and an ingress node for taking into account configuration attributes for timer values during configuration of a network connection.

According to one aspect of the present invention a method in an ingress node of a network for Operation Administration and Maintenance, OAM related to Resource Reservation Protocol-Traffic Engineering, RSVP-TE, for obtaining attributes for timer values being assigned to a connection from the ingress node via intermediate nodes to an egress node, during configuration of the connection, is disclosed. The method comprises specifying an interval of suitable timer values for the intermediate nodes, based on Traffic Engineering information of one or more nodes in the network. The method comprises obtaining configuration attributes for a timer value within an interval that is acceptable by the intermediate nodes and the egress node, based on the specified interval of suitable timer values, and applying the obtained configuration attributes during an updated configuration of the connection from the ingress node via the intermediate nodes to the egress node, if the obtained configuration attributes are appropriate to the ingress node.

The method for obtaining attributes for timer values being assigned to a connection, may comprise providing the interval of suitable timer values to at least one intermediate node, in an initial PATH setup message of the connection between the ingress node and the egress node.

The method for obtaining attributes for timer values being assigned to a connection, may comprise the step of obtaining a timer value selected from the interval that is acceptable by the intermediate nodes and by the egress node.

The step of applying the obtained configuration attributes during configuration within the method for obtaining attributes for timer values being assigned to a connection, may comprise applying the obtained attributes for an updated PATH setup message.

The step of obtaining a timer value selected from the interval within the method for obtaining attributes for timer values being assigned to a connection, may comprise selecting the timer value from the interval that is acceptable by the intermediate nodes and by the egress node.

The step of obtaining a timer value selected from the interval, within the method for obtaining attributes for timer values being assigned to a connection may comprise receiving from the egress node the timer value from the interval that is acceptable by the intermediate nodes and by the egress node.

The step of obtaining configuration attributes for a timer value, within the method for obtaining attributes for timer values being assigned to a connection may comprise receiving setup attributes for the timer value.

The step of specifying an interval of suitable timer values, within the method for obtaining attributes for timer values being assigned to a connection may further be based on capabilities and interfaces of said intermediate nodes.

The step of specifying an interval of suitable timer values, within the method for obtaining attributes for timer values being assigned to a connection may further be based on capabilities and interfaces of the egress node.

The interval of suitable timer values may be encoded in a sub Type Length Value, TLV.

The interval of suitable timer values may comprise a hold-off timer interval.

The interval of suitable timer values, within the method for obtaining attributes for timer values being assigned to a connection, may comprise a confirmation time interval.

The method for obtaining attributes for timer values being assigned to a connection, may further comprise rejecting the obtained configuration attributes as obtained from the egress node, if the obtained configuration attributes are not appropriate to the ingress node.

According to another aspect of the present invention an ingress node of a network for Operation Administration and Maintenance, OAM related to Resource Reservation Protocol-Traffic Engineering, RSVP-TE, for obtaining attributes for timer values being assigned to a connection from the ingress node via intermediate nodes to an egress node, during configuration of the connection, is disclosed. The ingress node comprises a control unit that is configured to specify an interval of suitable timer values for the intermediate nodes, based on Traffic Engineering information of one or more nodes in the network. The ingress node also comprises transceiving means operatively connected to the control unit, and configured to obtain configuration attributes for a timer value within an interval that is acceptable by the intermediate nodes and the egress node, based on the specified interval of suitable timer values. Moreover, the control unit is further configured to apply the obtained configuration attributes during configuration of the connection from the ingress node via the intermediate nodes to the egress node, if the obtained configuration attributes are appropriate to the ingress node.

Embodiments of the present invention come with the following advantages:

They allow fine-tuning the connection related timers and allows revision of some connection attributes. This allows per connection fine-tuning of the hold-off timer and the continuity check functions in order to decrease the overall recovery times and or decrease the monitoring overhead.

### BRIEF DESCRIPTION OF DRAWINGS

These and other aspects, features and advantages of which the invention is capable of will be apparent and elucidated from the following description of embodiments of the present invention, reference being made to the accompanying drawings, in which

FIG. 1 schematically illustrates a communication network related to embodiments of the present invention;

FIGS. 2-6 illustrate method steps of flow-charts according to embodiments of the present invention; and

FIG. 7 schematically illustrates a network node according to embodiments of the present invention.

### ABBREVIATIONS

3GPP Third Generation Partnership Project
CC Continuity Check
GMPLS Generalized Multiprotocol Label Switching
HOFF Hold-OFF
ISIS-TE Intermediate System to Intermediate System-Traffic Engineering
MPLS MultiProtocol Label Switching
MPLS-TP MultiProtocol Label Switching-Transport Profile
OAM Operation, Administration and Maintenance
OSPF-TE Open Shortest Path First-Traffic Engineering
OTN Optical Transport Networks
SDH/Sonet Synchronous Digital Hierarchy/Synchronous optical networking
PBB-TE Provider Backbone Bridging with Traffic Engineering
RSVP-TE Resource Reservation Protocol with Traffic Engineering
TLV Type-Length-Value
WTR Wait-to-Restore
WSON Wavelength Switched Optical Networks

### DETAILED DESCRIPTION

Embodiments of the present invention propose that timers assigned to a connection are determined as part of the connection configuration process by the ingress node of that connection.

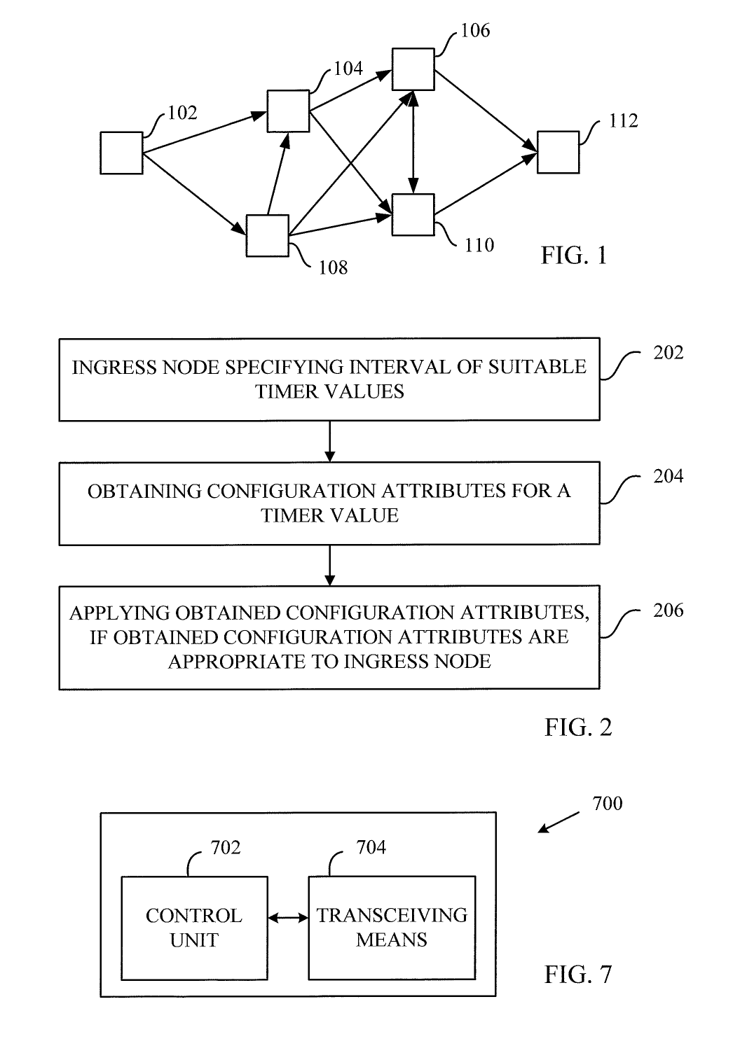

Reference is now made to FIG. 1 schematically presenting communication network comprising an ingress node 102, intermediate nodes 104, 106, 108, 110 and an egress node 112. A connection is typically connection from the ingress node, via one or more intermediate nodes to the egress node.

An interval of suitable timer values can first be constructed and provided to by the ingress node to the down-stream intermediate nodes and to the egress node. Then, each down-stream intermediate node and finally the egress node can adjust the interval of suitable timer values. The ingress node then typically receives an acceptable timer value interval from the egress node. The ingress node may then alter the connection configuration and start establishing or refresh the connection based to the new configuration.

According to a flowchart of a general embodiment of the present invention a first step in the method in an ingress node 102 for obtaining attributes for timer values being assigned to a connection from the ingress node via intermediate nodes 104, 106, 108, 110 to an egress node 112, during configuration of the connection, comprises specifying an interval of suitable timer values, based on Traffic Engineering information of one or more nodes in the network, step 202.

Based on the interval of suitable timer values, the ingress node 102 obtains configuration attributes for a timer value within an interval, during configuration of the connection between the ingress node via the intermediate nodes 104, 106, 108, 110, to the egress node, where the timer value is acceptable by the intermediate nodes and the egress node, in step 204. The ingress node 102 then applies the obtained configuration attributes, if the obtained configuration attributes are appropriate to the ingress node, during an updating of the configuration of the connection from the ingress node 102 via the intermediate nodes to the egress node 112, in step 206.

Embodiments of the invention propose that the per-connection adjustable timers are optimized during the connection setup.

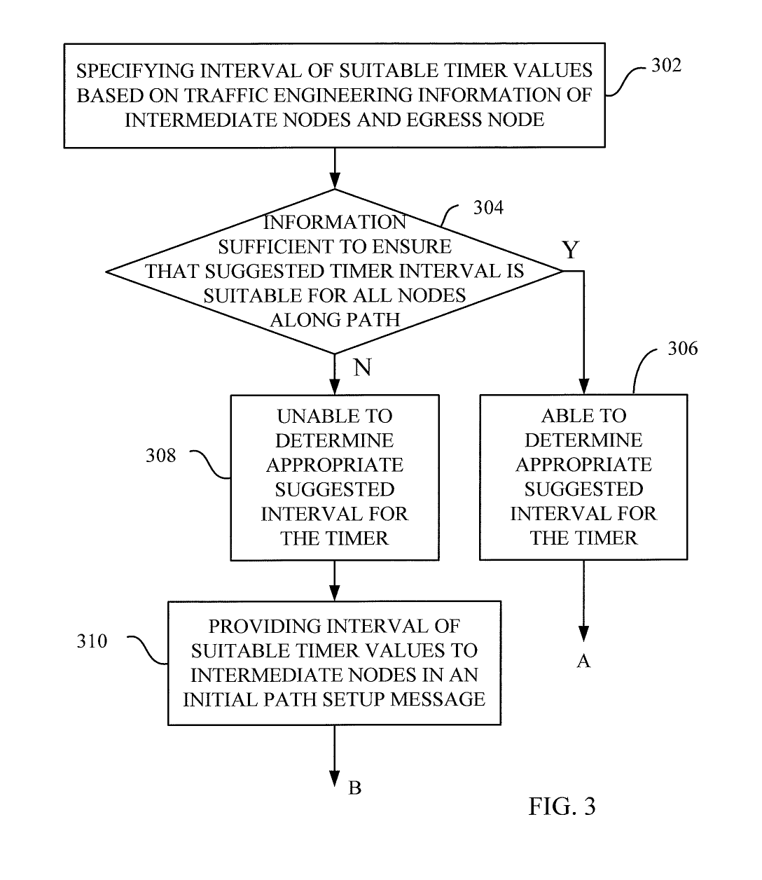

With reference to a few figures presenting a flowchart of method steps for obtaining attributes for timer values being assigned to a connection from the ingress node via intermediate nodes to an egress node, during configuration of the connection, embodiments of the present invention will now be described. Starting with FIG. 3, the first step 302, comprises specifying an interval of suitable timer values based on traffic engineering information of intermediate nodes and egress node.

The ingress node may take into account the local capabilities of the ingress node including data interfaces with other nodes. The ingress node may hence take into account relevant Traffic Engineering (TE) information as advertised by other nodes and refine a suggested interval of suitable timer values. For instance, the ingress node can suggest a timer value interval for its interfaces or it can provide other relevant information such as protection type.

In step 304, the ingress node determines whether it has sufficient information to ensure that the suggested interval of timer values is suitable for all nodes along the path of the connection from the ingress node to the egress node.

In the case the ingress node indeed has sufficient information to ensure that the suggested timer interval is suitable for all nodes along the path between the ingress node and the egress node, it is determined that the ingress node is able to determine an appropriate suggested interval of timer values, step 306. In this case there is no need to perform an interval discovery step passing the intermediate nodes.

This has the effect that the ingress node subsequently can apply the obtained configuration attributes in an updated path setup message, following A to step 410. This updates setup message is then addressed to the down-streams intermediate nodes as well as to the egress node for said connection.

However, if the information of the ingress node is not sufficient to ensure that the suggested timer interval is suitable for all nodes along the path, in step 304, the ingress node is not able to determine appropriate interval for the timer in step 308.

In this case the ingress node provides an interval of suitable timer values to the intermediate nodes in an initial PATH setup message, in step 310.

The ingress node initiates configuration setup with partial or default settings and will include its suggested interval into the initial path setup message. It can thus be considered that the connection is now partially configured, since the timer attributes are not yet set yet. The connection between the ingress node via the intermediate nodes to the egress node can therefore said to be established.

It can further be noted for completeness that each intermediate node along the connection will evaluate the received suggested interval of timer values by forming an intersection of the received suggested interval of timer values and an interval formed by timer values supported by said intermediate node.

In the case there is no timer value that is acceptable by both the current node and all upstream nodes, the intersection interval is the empty interval. In this case, the intermediate node must reject the connection setup and raise an error.

In the case the intersection is not an empty interval, the updated suggested interval or domain will be the just validated and calculated interval or domain and passed to a next-hop node.

Having reached the egress node 112, the ingress node 102 can receive a timer interval that is validated by all intermediate nodes 104-110 along the path between the ingress node and the egress node.

Depending on various embodiments of the present invention, the ingress node receives various messages.

According to a first embodiment of the present invention, the ingress node 102 receives an interval of appropriate tinier values from the egress node. According to this embodiment, the ingress node receives a hold-off timer value interval which thus is acceptable by the intermediate nodes and the egress node, in step 402.

This hold-off timer value interval is received in a RESV message from the egress node 112.

The ingress node can then select a hold-off timer value from the received acceptable timer value interval, step 404.

Then, based on the select a hold-off timer value the ingress node now obtains configuration attributes for the selected hold-off timer value, step 406. Subsequently, it is determined whether the attributes are appropriate to the ingress node, or not, step 408.

If they are appropriate to the ingress node 102, it applies said obtained configuration attributes in an updated PATH setup message by which the connection configuration is updated, step 410. If they are not appropriate to the ingress node, the ingress node 102 rejects the obtained configuration attributes in an RESV error message, step 412.

When the ingress node calculates the initial suggested suitable interval or timer values, as described in connection to step 302, it can consider not only its local capabilities but it may take into account the relevant capabilities provided by the other nodes. A logical approach for that purpose is that any node advertises acceptable tinier intervals as Traffic Engineering (TE) attributes assigned to interfaces to other nodes using for instance Open Shortest Path First (OSPF)-TE or Intermediate System to Intermediate System (ISIS)-TE. For this purpose, a new type of Type-Length-Value (TLV) is now introduced. Each timer interval TLV comprises of a field identifying the timer and two fields encoding the lower and higher bounds of the acceptable timer interval.

An advertisement may carry several timer interval TLVs. At most one TLV can refer to a specific timer. If several TLVs refer to one and the same timer, the first is applied and the others are being discarded.

The advertisement of this timer information is done by adding the Supported Timer Interval TLVs to the Traffic Engineering (TE)-link information advertised by the routing protocols included in Generalized Multiprotocol Label Switching.

Within said first embodiment of the present invention, Resource ReSerVation Protocol (RSVP)-TE signaling extension is provided on how the hold-off timer can be adjusted.

Within said first embodiment an interval of the acceptable hold-off timer values is defined. The interval is characterized by its endpoints, of which one is a lower and the other a higher bound. The interval is encoded as a new sub-Type-Length-Value (TLV) carried in an extended version RSVP-TE PROTECTION object, by “Min acceptable HOFF” and “Max acceptable HOFF” attributes.

It is thus the ingress node 102 that determines both the “Min acceptable HOFF” and the “Max acceptable HOFF” values. These attributes are encoded in the Hold-off timer discovery TLV that is included into the PROTECTION object.

It can further be mentioned that any intermediate node along the path can match the interval of the acceptable hold-off timer values received from the upstream node to the configuration of the incoming and the outgoing links of the particular intermediate node.

For completeness it can be mentioned that the acceptable hold-off timer interval can be updated by setting an updated “Min acceptable HOFF” to the maximum of the received “Min acceptable HOFF” and the lower timer bounds acceptable by the incoming and outgoing links.

The updated “Max acceptable HOFF” will consequently be the minimum of the received “Max acceptable HOFF” and the higher timer bounds assigned to the incoming and outgoing links.

In the case the updated acceptable hold-off timer interval comprises timer values, i.e. it is not empty, the particular node continues the connection signaling procedures.

In the case the updated or revised acceptable hold-off timer interval is empty, the node must cancel the signaling session and raise an error message.

It can be added that, if an upstream node uses the Hold-OFF (HOFF) timer sub-TLV, it can be considered to be a single element interval, in the sense that both “Min acceptable HOFF” and “Max acceptable HOFF” attributes are set to that timer value. Then, the above described matching procedure applies without any modifications.

It can further be pointed out that, although the intermediate nodes 104-110 are not involved in end-to-end protection and they are unaware of the finally selected hold-off tinier value, they may play key role in determining the HOFF timer value. The egress node 112 and ingress node 102 have to select such a hold-off timer interval that is supported by all nodes along the path.

Whereas the first embodiment of the present invention can be considered to be a hold-off timer discovery TLV embodiment, a second embodiment of the present invention relates to a Resource ReSerVation Protocol (RSVP)-TE signaling extension on how the hold-off timer and a detection time can be discovered and adjusted together.

Similar to the first embodiment, this extension proposes a two-step configuration, wherein a first iteration comprises configuration of the connection, after which timer discovery information is received by the ingress node. In a second iteration the connection configuration is updated according to the discovered timer values.

Within the second embodiment a confirmation time discovery Type-Length-Value (TLV) is introduced. The Confirmation time is defined as the sum of the detection time and the hold-off time. The Confirmation time discovery TLV defines the domain or range of acceptable confirmation times of the sending node as a time interval. This interval is encoded with a lower bound of the confirmation time “Min acceptable Confirm” attribute and a higher bound of the confirmation time “Max acceptable Confirm” attribute.

This second embodiment uses a discovery mechanism similar to the one of the first embodiment. Within the second embodiment an acceptable timer interval for the entire confirmation time is determined, whereas in the first embodiment the acceptable timer interval only considered the hold-off timer.

The method steps as presented in the flowchart of FIG. 3 therefore apply to this second embodiment, with the timer being a confirmation timer instead of a hold-off timer.

If the information of the ingress node 102 is not sufficient to ensure that suggested confirmation timer interval is suitable to all nodes along the path, in step 304, the ingress node is unable to determine an appropriate confirmation timer interval in step 308 and the ingress node provides initial suitable timer values in an initial PATH setup message, sent to the nodes along the path, in step 310.

Again it can be mentioned that the egress node 112 then reports back a discovered acceptable interval of confirmation time to the ingress node. Accordingly, the ingress node 102 receives a confirmation timer value that is selected by the egress node, which is acceptable by the intermediate nodes and the egress node.

Based on the received confirmation time interval, the ingress node first determines suitable Continuity Check (CC) configuration attributes. Thereafter, the ingress node calculates the hold-off timer such that the sum of the detection time provided by the CC and the hold-off timer falls within the reported confirmation time domain or range. The ingress node thus obtains configuration attributes for the selected confirmation timer value, in step 504.

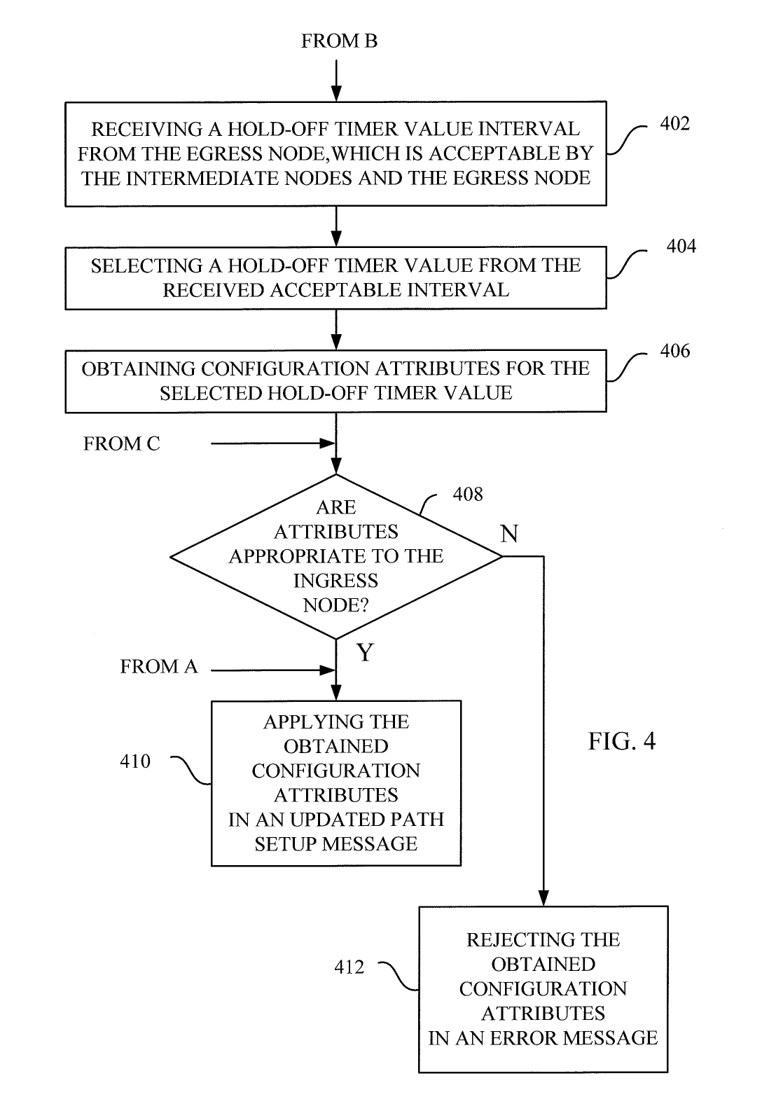

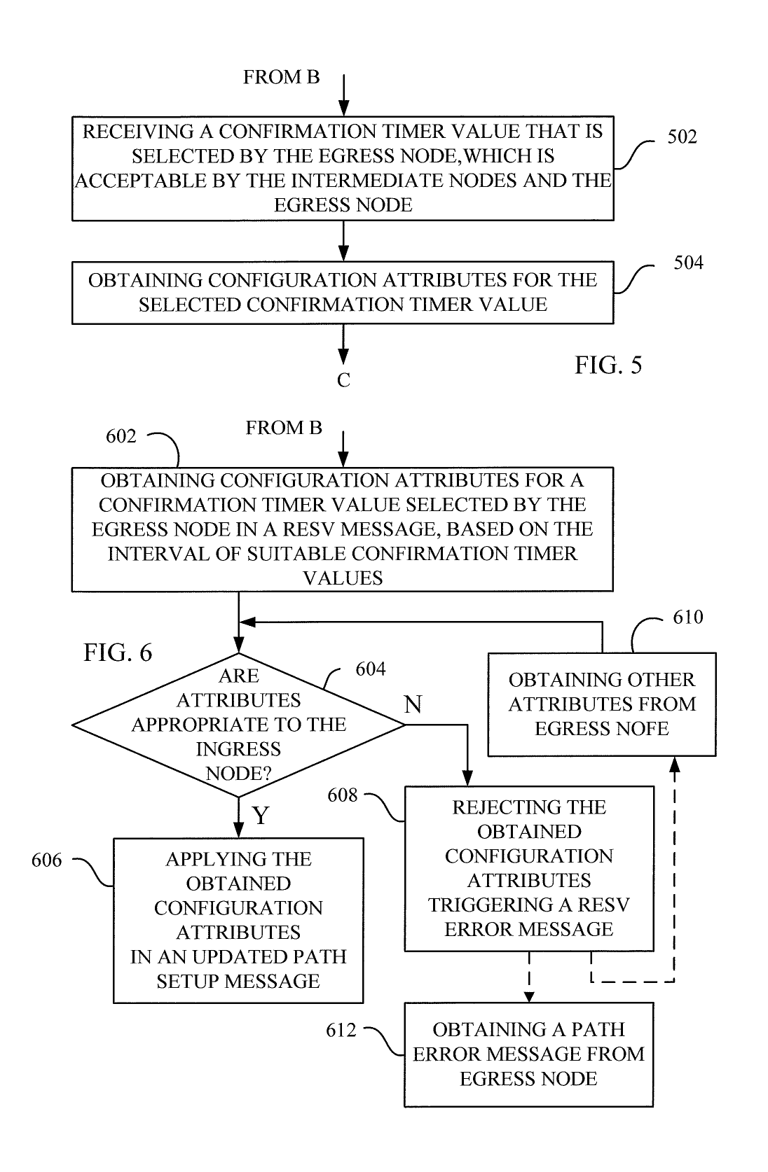

After step 504, foil owing C in FIG. 5, leads to step 408 in FIG. 4 in which the ingress node determines whether the determined attributes are appropriate to the ingress node or not. If they are, step 410 follows in which the obtained configuration attributes are applied in an updated PATH setup message.

Here the ingress node 102 thus updates the connection setup. The updated PATH setup message is sent carrying the updated CC configuration and the hold-off timer value.

It can be noted that this second path message should however not carry the confirmation time discovery TLV. However, it is possible that the hold-off timer and CC configuration are revised during the lifetime of the connection. Then the same discovery and refresh procedures apply as in case of initial connection setup.

A third embodiment of the present invention concerns an Operation, Administration and Maintenance (OAM) update method to discover an acceptable confirmation time domain including a hold-off time adjustment and to configure the connection appropriately in one signaling transaction.

As previously described, the ingress node 102 here specifies an initial domain or interval for the acceptable confirmation times which is described with the “Min acceptable Confirm” and “Max acceptable Confirm” attributes. Any intermediate nodes along the path may again narrow this interval using similar procedures as described in the second embodiment above.

Similar to above, the method steps in the flowchart of FIG. 3 again apply, with the exception that the timer interval now refers to a confirmation time.

For completeness it can be mentioned that the egress node determines the suitable continuity check (CC) configuration attributes and a proper hold-off timer considering the acceptable confirmation time domain defined by the “Min acceptable Confirm” and “Max acceptable Confirm” attributes, as mentioned above.

Moreover, if the Continuity Check function is not requested by the ingress node using an OAM Configuration TLV, the hold-off timer will be set to the confirmation time. Otherwise, the CC configuration attributes are determined, which define the detection time, and the hold-off timer taking the transport technology's characteristics into account.

Also, the egress can then configure itself and prepares a connection setup response message in the form of a RESV message. The ingress node 102 then receives a selected hold-off timer value and the revised continuity check CC configuration attributes.

According to this third embodiment of the present invention, the ingress node thus obtains configuration attributes for a confirmation timer value selected by the egress node, in step 602.

It must he noted that the OAM Configuration framework must be extended in order to provide the Continuity Check (CC) configuration attributes to the ingress node. The ingress node can specify the OAM configuration, including the CC function to be used by the egress. When a specific parameter, for instance the CC attributes, is not encoded a default value is to be used. Within this embodiment, an alternative is added to this operation. If some parameters are not specified by the ingress node 102, the egress node 112 may select other values than the default ones. Thereafter the ingress node 102 receives a report from the egress node 112. For this reason the egress node performs the following steps:

The OAM Configuration Type-Length-Value (TLV) and the technology specific Configuration TLVs from a Label Switched Path (LSP) ATTRIBUTES object, are copied to the LSP_ATTRIBUTES to the corresponding RESV message.

The technology specific OAM configuration TLV is extended with the egress determined configuration attributes.

The selected hold-off timer value included into the PROTECTION object using the Hold-off timer TLV.

The ingress node now receives the RESV message, as sent by the egress node, with this revised OAM configuration.

The ingress node 102 now determines whether the obtained configuration attributes are appropriate to the ingress node or not, in step 604. If they are, as determined in step 604, the ingress node revises its local OAM configuration and applies the obtained configuration attributes in an updated PATH setup message, in step 606.

If the ingress node 102 however rejects the obtained configuration attributes in step 608 and a RESV error message addressed to the egress node is triggered.

Thereafter, the egress may send another RESV message with other parameters, leading to the ingress node obtains other attributes from the egress node in step 610, after which the ingress node 102 determines whether these obtained other attributes are appropriate to the ingress node or not, in step 604.

Alternatively, the ingress node 102 receives surely inappropriate attributes selected by the egress node 112, ensuring that the connection will be destructed by the ingress node 102.

Within a fourth embodiment of the present invention Traffic Engineering (TE) advertisement is used. In this case every node, which terminate recovery capable TE-Links advertise acceptable timer intervals of the hold-off timer or the overall confirmation time for each terminated TE-Links.

In order to achieve this Acceptable Timer Interval TLVs are included, where a Timer ID defines whether the TLV encodes an interval of the hold-off timer by having the Timer ID set to 1 or an interval of the confirmation time by having the Timer ID set to 2.

Based on the advertisement information, the ingress node calculates a common timer interval. Then depending on which of the timers is advertised the ingress node performs one of the following options:

When only the hold-off timer intervals are advertised, the ingress node picks one value of the common interval.

When the confirmation timer intervals are advertised, the ingress node calculates a suitable hold-off timer and a suitable OAM configuration.

When the ingress node knows both the confirmation time and the hold-off timer intervals, the ingress node calculates two common timer intervals and considers both during hold-off timer optimization.

Thereafter, in all cases signaling between the ingress node and the intermediate nodes and the egress node is done according to state-of-the-art.

Regarding detection time and hold-off timer optimization, it can be mentioned the following.

The second, third and fourth embodiments consider the confirmation time as the sum of the detection time and the hold-off time. While the hold-off time can be adjusted with an explicit set timer, the detection time is implicitly influenced by configuring the continuity check monitoring function of OAM. For connection oriented packet switched technologies, like Multi Protocol Label Switching (MPLS)-Transport Profile (TP) and Provide Backbone Bridging (PBB)-Traffic Engineering (TE), this CC function is implemented as a periodic heartbeat of monitoring packet. Different packet rates will enable different detection times, but the lower frequency is selected, the lower bandwidth consumption of the monitored packet flow is used.

The node, which calculates the detection and hold-off times, shall determine the largest supported detection time smaller than the selected confirmation time. When this selected detection time is smaller than the desired confirmation time, the hold-off timer can be set to this difference.

This selection ensures that the connection will be monitored at the lowest acceptable CC monitor message rate that provides the demanded confirmation time.

With reference to FIG. 7, an ingress node according to some embodiments of the present invention is schematically presented. The ingress node 700 of a network for Operation Administration and Maintenance, OAM related to Resource Reservation Protocol-Traffic Engineering, RSVP-TE, is configured for obtaining attributes for timer values being assigned to a connection from the ingress node via intermediate nodes to an egress node, during configuration of the connection. The ingress node comprises a control unit 702 that is configured to specify an interval of suitable timer values for the intermediate nodes, based on Traffic Engineering information of one or more nodes in the network, and transceiving means 704 operatively connected to the control unit 702, and configured to obtain configuration attributes for a timer value within an interval that is acceptable by the intermediate nodes and the egress node, based on the specified interval of suitable timer values. The control unit 702 is further configured to apply the obtained configuration attributes during configuration of the connection from the ingress node via the intermediate nodes to the egress node, if the obtained configuration attributes are appropriate to the ingress node.

It must be emphasized that the present invention can be varied in many ways.

The presented embodiments of the present invention are only a few examples of the variety of embodiments that are comprised within the present invention.

The embodiments of the present invention provide at least the following advantages:

Embodiments of this invention allow fine-tuning the connection related timers and allows revision of some connection attributes. This allows per connection fine-tuning of the hold-off timer and the continuity check functions in order to decrease the overall recovery times and or decrease the monitoring overhead.

The elements and components of an embodiment of the invention may be physically, functionally and logically implemented in any suitable way. Indeed, the functionality may be implemented in a single unit, in a plurality of units or as part of other functional units. As such, the invention may be implemented in a single unit, or may be physically and functionally distributed between different units and processors.

Although the present invention has been described above with reference to (a) specific embodiment(s), it is not intended to be limited to the specific form set forth herein. Rather, the invention is limited only by the accompanying claims and, other embodiments than the specific above are equally possible within the scope of these appended claims.

It is made clear that presented embodiments may well be combined forming new embodiments not explicitly described herein.

In the claims, the terms “comprises/comprising” does not exclude the presence of other elements or steps. Furthermore, although individually listed, a plurality of means, elements or method steps may be implemented by e.g. a single unit or processor. Additionally, although individual features may be included in different claims, these may possibly advantageously be combined, and the inclusion in different claims does not imply that a combination of features is not feasible and/or advantageous. In addition, singular references do not exclude a plurality, The terms, “a”, “an”, “first”, “second” etc do not preclude a plurality. Reference signs in the claims are provided merely as a clarifying example and shall not be construed as limiting the scope of the claims in any way.

1. A method in an ingress node of a network for Operation Administration and Maintenance, OAM related to Resource Reservation Protocol-Traffic Engineering, RSVP-TE, for obtaining attributes for timer values being assigned to a connection from the ingress node via intermediate nodes to an egress node, during configuration of the connection, said method comprising:
specifying an interval of suitable timer values (steps 202, 302) for the intermediate nodes, based on Traffic Engineering information of one or more nodes in the network,
obtaining configuration attributes (steps 204, 406, 504, 602, 610) for a timer value within an interval, during configuration of the connection from the ingress node via the intermediate nodes to the egress node, which interval is acceptable by the intermediate nodes and the egress node, based on the specified interval of suitable timer values, and
applying the obtained configuration attributes (steps 206, 410, 606) during an updating of the configuration of the connection from the ingress node via the intermediate nodes to the egress node, if the obtained configuration attributes are appropriate to the ingress node.

2. The method of claim 1, further comprising providing the interval of suitable timer values (step 310) to at least one intermediate node, in an initial PATH setup message of the connection between the ingress node and the egress node.

3. The method of claim 1, further comprising the step of obtaining a timer value (step 402) selected from the interval that is acceptable by the intermediate nodes and by the egress node.

4. The method of claim 1, wherein the step of applying the obtained configuration attributes (steps 206, 410, 606) during configuration further comprises applying the obtained attributes for an updated PATH setup message.

5. The method of claim 3, wherein the step of obtaining a timer value selected from the interval (step 402), comprises selecting the timer value from the interval that is acceptable by the intermediate nodes and by the egress node.

6. The method of claim 3, wherein the step of obtaining a timer value selected from the interval (step 502), comprises receiving from the egress node the timer value from the interval that is acceptable by the intermediate nodes and by the egress node.

7. The method of claim 1, wherein the step of obtaining configuration attributes for a timer value (step 602), comprises receiving setup attributes for the timer value.

8. The method of claim 1, wherein the step of specifying an interval of suitable timer values (steps 202, 302) further is based on capabilities and interfaces of said intermediate nodes.

9. The method of claim 1, wherein the step of specifying an interval of suitable timer values (steps 202, 302) further is based on capabilities and interfaces of said egress node.

10. The method of claim 1, wherein the interval of suitable timer values is encoded in a sub Type-Length-Value, TLV.

11. The method of claim 1, wherein the interval of suitable timer values comprises a hold-off timer interval.

12. The method of claim 1, wherein the interval of suitable timer values comprises a confirmation time interval.

13. The method of claim 1, further comprising rejecting the obtained configuration attributes as obtained from the egress node, if the obtained configuration attributes are not appropriate to the ingress node.

14. An ingress node of a network for Operation Administration and Maintenance, OAM related to Resource Reservation Protocol-Traffic Engineering, RSVP-TE, for obtaining attributes for timer values being assigned to a connection from the ingress node via intermediate nodes to an egress node, during configuration of the connection, the ingress node comprising:
a control unit configured to specify an interval of suitable timer values for the intermediate nodes, based on Traffic Engineering information of one or more nodes in the network, and
transceiving means operatively connected to the control unit, and configured to obtain configuration attributes for a timer value within an interval that is acceptable by the intermediate nodes and the egress node, based on the specified interval of suitable timer values,
wherein the control unit further is configured to apply the obtained configuration attributes during an updating of the configuration of the connection from the ingress node via the intermediate nodes to the egress node, if the obtained configuration attributes are appropriate to the ingress node.
